(19) United States
(12) Patent Application Publication
(10) Pub. No.: US 2014/0187625 A1
(43) Pub. Date: Jul. 3, 2014

(54) RODENTICIDAL COMPOUND, COMPOSITION INCLUDING SAME AND USE FOR COMBATING RODENT PESTS

(71) Applicants: Herve Caruel, Moncaut (FR); Adrien Montagut Romans, Lyon (FR); Etienne Benoit, Lyon (FR); Stephane Besse, Francheville (FR); Philippe Berney, Vaugneray (FR); Virginie Lattard, Lyon (FR)

(72) Inventors: Herve Caruel, Moncaut (FR); Adrien Montagut Romans, Lyon (FR); Etienne Benoit, Lyon (FR); Stephane Besse, Francheville (FR); Philippe Berney, Vaugneray (FR); Virginie Lattard, Lyon (FR)

(73) Assignee: LIPHATECH, Pont-du-Casse (FR)

(21) Appl. No.: 14/234,190

(22) PCT Filed: Jul. 19, 2012
(86) PCT No.: PCT/FR2012/051707

§ 371 Date: Jan. 22, 2014

(30) Foreign Application Priority Data
Jul. 22, 2011 (FR) 11 56681

(51) Int. Cl. A01N 43/16

(52) U.S. Cl. CPC A01N 43/16
USPC 514/457; 549/285

(57) ABSTRACT

A novel compound obtained from molecules of the coumarin family, which exhibits rodenticidal activity. Also, compositions which incorporate such compounds and the use thereof for combating rodent pests.

The present invention relates to the field of rodenticidal products, that is to say products which have the property of killing rodents.

The invention provides in particular novel molecules having a rodenticidal effect and compositions comprising them. It also relates to the use of these molecules and compositions for combating rodent pests.

The damage caused by certain pests, such as rats or mice, has been known for a long time, and the risks associated with their presence are serious.

In addition to material damage which they may cause, in particular on electrical installations, damage to crops and stored foodstuffs, rodent pests especially constitute a significant health hazard. Directly or through their parasites, they are the cause of numerous diseases transmitted to humans and to domestic animals, such as tetanus, streptobacillosis, pasteurellosis, leptospirosis, salmonellosis, hemorrhagic fevers or also the plague.

For this reason for several years various disinfestation systems have been developed: physical systems, for example based on mechanical traps, glues or also ultrasound, and chemical systems, in particular repellent, chemosterilizing or rodenticidal products. Although the use of physical systems is increasing, control of rodent populations is always chiefly realized from the angle of combating methods using rodenticides, in particular because of the existence of a thoroughly effective antidote in the event of accidental poisoning and due to the efficacy in the event of massive infestations.

Rodenticides belong to very diverse chemical families: anticoagulant, convulsant, cardiotoxic, cytotoxic or hypercalcemic agents. The majority of rodenticides used today are anticoagulants, in particular anticoagulants derived from 4-hydroxycoumarin or coumaphen, such as coumachlor, coumatetralyl, difenacoum or brodifacoum, bromadiolone, anticoagulants derived from 4-hydroxythiocoumarin, such as difethialone, and anticoagulants derived from indane-1,3-dione, such as chlorophacinone, diphacinone.

The metabolism of anticoagulants is characterized by a good oral absorption and an essentially hepatic distribution. These products are therefore very effective. They act by accumulation for several days until death of the animal is caused by acute hemorrhagia, without suffering and without raising suspicion in its congeners towards the product.

However, the majority of rodenticidal anticoagulants currently in existence have a high persistence and persist for a long time in the animals which have consumed them. Thus, since these are non-selective toxic products, predatory species of rodents, in particular birds of prey and small wild or domestic mammals, may become poisoned themselves with these anticoagulants which they consume indirectly through poisoned rodents.

To alleviate these disadvantages, compounds have been proposed in the patent application FR-1051155.

The object of the present invention is to propose a novel solution which enables effective combating of rodents while reducing the risks of secondary poisoning of non-targeted fauna.

To this effect, the invention provides a compound corresponding to the formula (I):

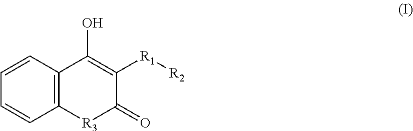

and its enantiomers, diastereoisomers, tautomers or mixtures of these in any proportions,
in which:
R1 represents: —H or

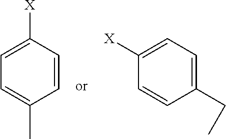

where X═H, OH, Cl, Br, F, CF₃ or N0₂,
R2 represents:

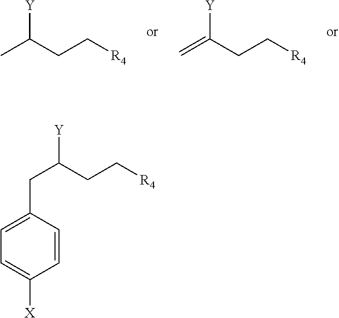

where X═H, OH, Cl, Br, F, CF₃ or NO₂,
R3 represents: O or S or CH—X,
   where X═H, OH, Cl, Br, F, CF₃ or NO₂,
R4 represents a carbon chain chosen from chains a) to l):

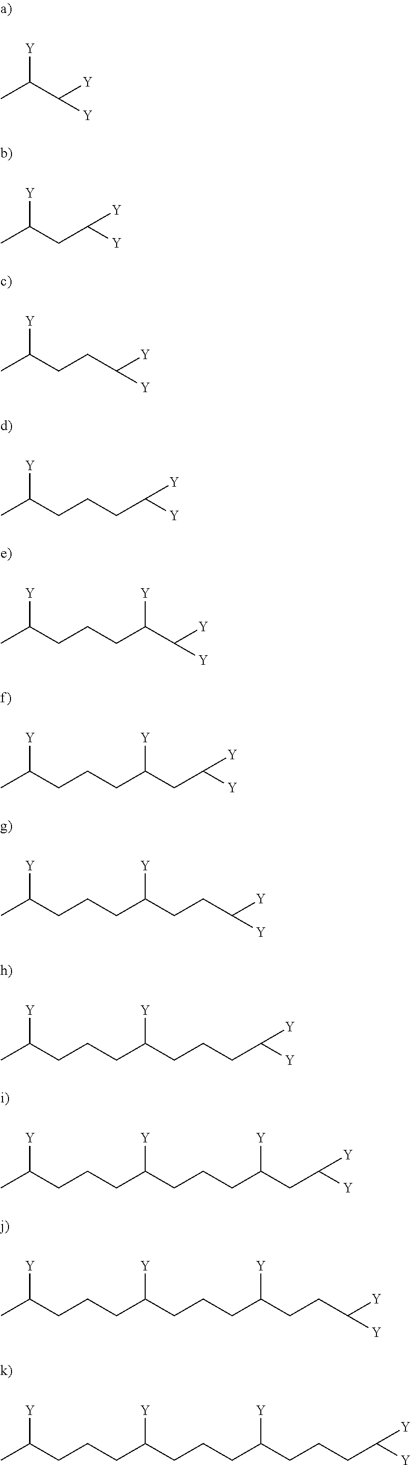

where Y═H or CH₃ when X═H, OH, Cl, Br, F, CF₃ or NO₂,

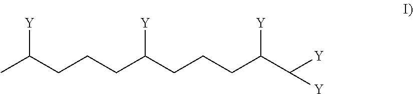

where Y═H when X═H, OH, Cl, Br, F, CF₃ or NO₂,
or where Y═CH₃ when X═CF₃,
X can be different or identical in R1, R2 or R3, and
Y can be different or identical when there are several Y in a same grouping R2.

The invention also provides a process for the production of a compound of the formula (I) from a molecule of the coumarin family.

The invention also relates to rodenticidal compositions comprising at least one compound corresponding to the formula (I). Preferably, these compositions are in the form of powders, blocks, gels, pastes, impregnated grains or also in liquid form.

Finally, the invention also provides the use of a compound of the formula (I) or of a composition including this for control of rodent populations.

The molecules according to the invention advantageously combine a true rodenticidal efficacy on all rodents and a very low hepatic persistence. Their use thus allows effective combating of rodents while considerably reducing the risk of secondary poisoning.

Other characteristics and advantages will emerge from the following detailed description of the invention.

According to a first aspect, the invention thus relates to a compound corresponding to the formula (I) below:

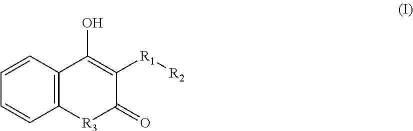

and its enantiomers, diastereoisomers, tautomers or mixtures of these in any proportions, in which:
R1 represents: —H or

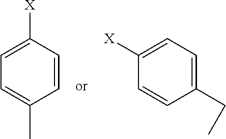

where X═H, OH, Cl, Br, F, CF₃ or NO₂,
R2 represents:

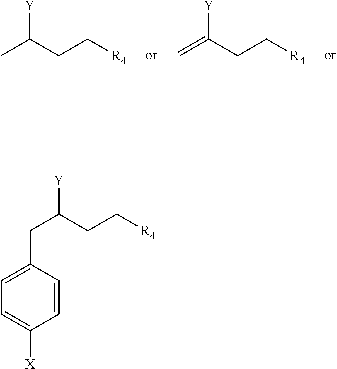

where X═H, OH, Cl, Br, F, CF₃ or NO₂,
R3 represents: O or S or CH—X,
   where X═H, OH, Cl, Br, F, CF₃ or NO₂,
R4 represents a carbon chain chosen from chains a) to l):

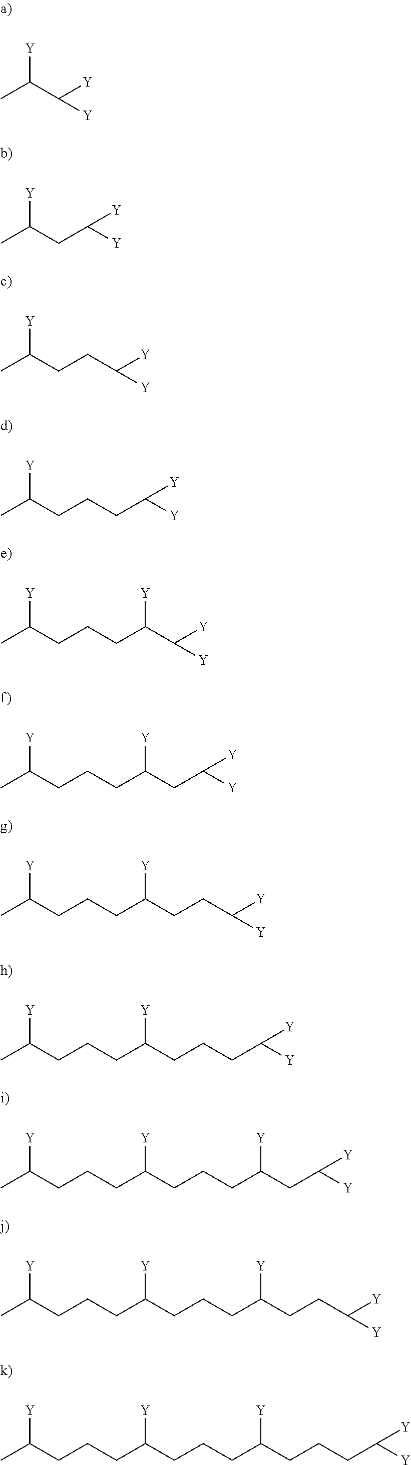

where Y═H or CH₃ when X═H, OH, Cl, Br, F, CF₃ or NO₂,

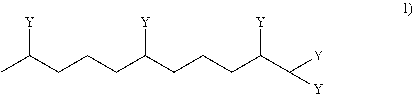

where Y═H when X═H, OH, Cl, Br, F, CF₃ or NO₂, or where Y═CH₃ when X═CF₃,
X can be different or identical in R1, R2 or R3, and
Y can be different or identical when there are several Y in a same grouping R2.

The grouping R1 is attached to the first carbon of the chain but does not constitute this first carbon.

When R1 represents —H, the compound according to the invention corresponds to the formula:

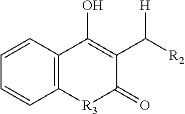

When R1 represents

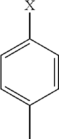

the compound according to the invention corresponds to the formula:

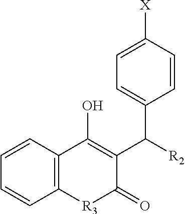

When R1 represents

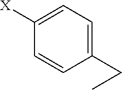

the compound according to the invention corresponds to the formula:

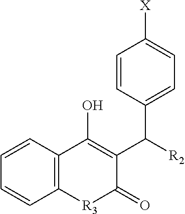

When R2 represents

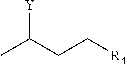

the compound according to the invention corresponds to the formula:

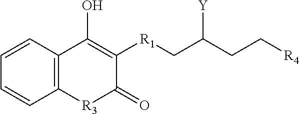

When R2 represents

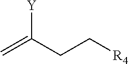

the compound according to the invention corresponds to the formula:

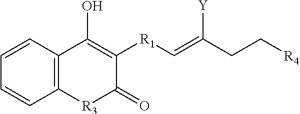

When R2 represents

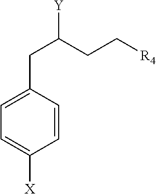

the compound according to the invention corresponds to the formula:

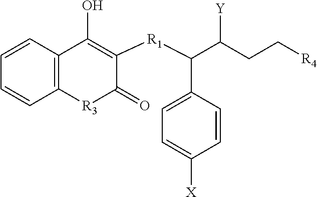

The compound according to the invention thus comprises a linear carbon chain having between 8 and 19 carbon atoms.

The invention also provides the enantiomers, diastereoisomers, tautomers of the compound of the formula (I) or a mixture of these in any proportions.

The compounds corresponding to this formula (I) and its enantiomers, diastereoisomers, tautomers or mixtures have a rodenticidal activity.

Preferably, R3 represents an oxygen 0.

Preferably, R4 is chosen from groupings b) to i) and 1), where Y═H, still more preferably d), e), f), i) and 1), where Y═H.

According to a particularly suitable embodiment, the invention provides a specific compound corresponding to the formula (I), in which:
R1 represents —H,
R2 represents

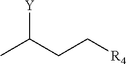

R3 represents O, and
R4 represents one of the chains a) to l), where Y═H.

By way of non-limiting example, this can be one of the compounds represented by the following formulae II to VII:

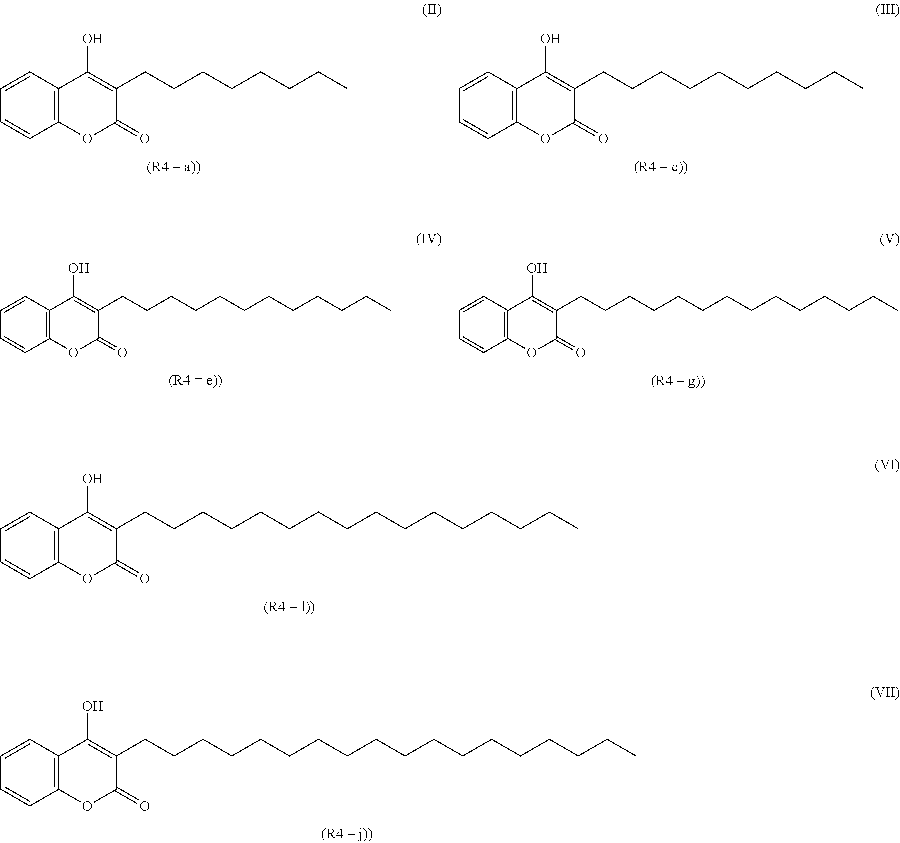 [SMILES: CCCCCCCCc1c(O)c2ccccc2oc1=O ; CCCCCCCCCCc1c(O)c2ccccc2oc1=O ; CCCCCCCCCCCCc1c(O)c2ccccc2oc1=O ; CCCCCCCCCCCCCCc1c(O)c2ccccc2oc1=O ; CCCCCCCCCCCCCCCCc1c(O)c2ccccc2oc1=O ; CCCCCCCCCCCCCCCCCCc1c(O)c2ccccc2oc1=O]

The compounds according to the invention can be obtained by grafting a branched and potentially more or less substituted aliphatic side chain on to a molecule of the coumarin family, in particular a 4-hydroxycoumarin or derivative.

By way of example, when R3=O, the compound is a 4-hydroxycoumarin, when R3=S, the compound is a 4-hydroxythiocoumarin.

The process for obtaining a compound of the formula (I) according to the invention can be shown in the form of an equation as follows:

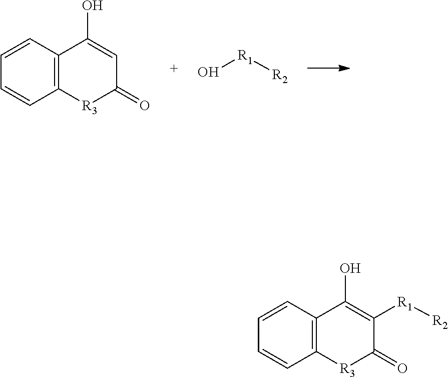

The grafting of the aliphatic chain can be carried out by any suitable grafting process.

It can be carried out, in particular, with the aid of a brominated derivative, in particular an alkyl bromide, as shown below:
preparation of the phenolate ion of 4-hydroxycoumarin (or derivative) with sodium hydroxide solution

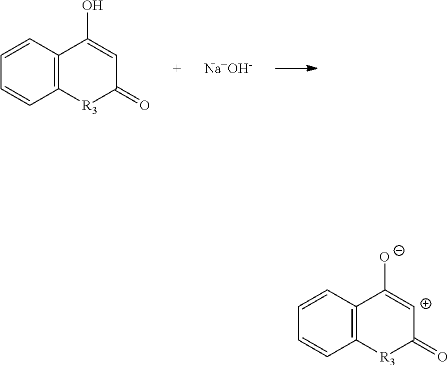

alkylation in position 3 on the coumarin nucleus in the presence of a solvent (for example ethanol)

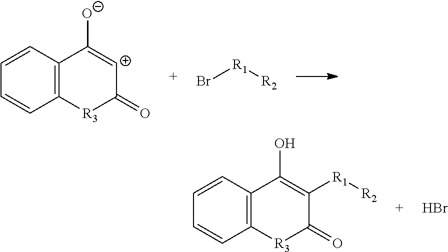

By way of example, the particular compound of the formula (II) can be obtained by carrying out the following steps:

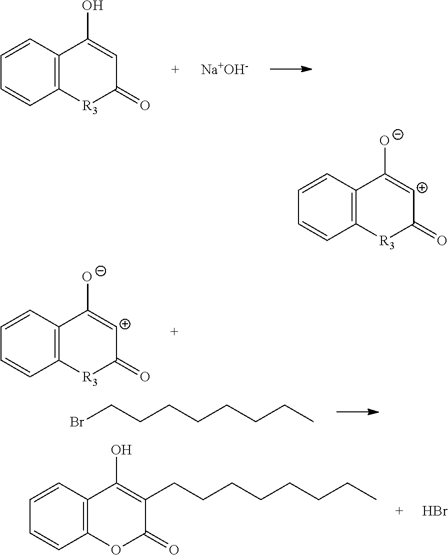

The step of preparation of the phenolate ion of 4-hydroxycoumarin can be carried out with a sodium hydroxide solution at between 60 and 80° C. for 20 to 40 minutes. The C-alkylation subsequently carried out corresponds to the attack of the alkyl bromide on a charged carbon in position 3 of the coumarin ring. The reaction takes place with a solvent, preferably ethanol, at a temperature of between 60 and 80° C. for about 1 to 6 days, depending on the length of the chain to be grafted.

It is to be pointed out the transition from a pale yellow color to orange or even dark red may be observed, depending on the chain lengths. The course of the reaction can be followed by HPLC.

The reaction medium is then purified by a succession of selective liquid/liquid extractions.

The compounds of the formula (I) according to the invention and their enantiomers, diastereoisomers, tautomers or mixtures of these have a significant rodenticidal effect even at a low concentration.

They can be incorporated into compositions intended for combating rodent pests.

The invention therefore also relates to rodenticidal compositions including as the active substance at least one compound of the formula (I).

Preferably, the invention provides rodenticidal compositions comprising between 0.001 and 50% by weight of a compound corresponding to the formula (I), still more preferably between 0.001 and 20%.

The compositions according to the invention can be in any form suitable for combating rodent pests. In particular, they can be in the form of a liquid concentrate, powder, grains, gels, pastes or extruded baits, such as pellets or blocks.

In addition to the compound of the formula (I), the compositions according to the invention comprise several excipients: one or more excipients making up the matrix containing the rodenticidal compound, and one or more excipients having a technological or biological role.

The excipients used in the matrix can be chosen in particular from mineral oils, carbohydrates, such as the dextrins, mineral substances, such as clay, glycols and other organic solvents, such as DMSO, water, cereal raw materials, such as barley, wheat, maize or rice, binders, such as paraffin.

The other excipients often used are, for example, additives which are appetizing and attractive to rodents, such as sugar or aromas, preservatives, or also bittering agents intended to reduce the risk of accidental consumption by children or domestic animals.

The compositions according to the invention can be produced by intimate and homogeneous mixing of the active compound or compounds of the formula (I) with carrier ingredients. This ease of realization is possible in particular because of the small amount of active compound required to obtain the desired rodenticidal effect.

The mixing of the active substance and excipients can be carried out by all suitable processes, in particular by convection, diffusion and/or subjecting to shear forces. For example, the mixing can be carried out in double-walled tanks allowing cooling or heating of the mixture as appropriate.

An example of a composition which is suitable according to the invention for presentation in the form of an extruded bait comprises the following components:
cereal raw materials (wheat, barley, maize, rice), preferably between 40 and 70% by weight of the composition,
a binder of the paraffin type or water, preferably between 15 and 40% by weight of the composition,
a compound of the formula (I), preferably between 0.001 and 50% by weight of the composition,
a bittering agent of the denatonium benzoate type,
one or more preservatives of the family of organic acids and their salts, such as ascorbic acid, propionic acid or potassium sorbate, and
a coloring agent, preferably the green coloring agent PG 7.

The production of the extruded carrier in a continuous process comprises the following steps:
mixing of ingredients with the aid of a mixer by convection,
extrusion with the aid of a single-screw extruder or twin-screw extruder of diameter 30 mm to 100 mm at between 55° C. and 95° C.,
shaping,
cutting into baits weighing between 5 and 100 g,
stabilization by heat treatment: cooling with pulsed air for 30 minutes or drying by convection for 2 to 10 hours, and
conditioning.

The compounds of the formula (I) and the compositions according to the invention can be used for combating rodent pests.

The rodenticidal compositions comprising the compounds of the formula (I) can be applied for prevention or for treatment in areas to be protected from attack by rodents. If appropriate, they can be inserted into or fixed in baiting boxes suitable for combating rodents in order to make their use safe.

Advantageously, the compounds of the formula (I) according to the invention have a very good rodenticidal efficacy at least as great as the existing anticoagulant rodenticides, while having a very low hepatic persistence. In fact, the compounds according to the invention are stored in the liver for a very limited time.

Their use thus allows effective combating of rodents while reducing the risk of secondary poisoning of non-targeted fauna.

They can be used in particular in the domestic environment, in the rural, professional, urban medium, in public catering or reception places, or also in the food processing industry for combating rats, mice, field mice, brown rats and/or any other rodent pest.

The dose of the compound to be administered depends on the intended rodent. It is preferably between 0.5 mg and 100 mg, depending on the rodent in question.

The invention is now illustrated by examples and results of tests demonstrating the effects claimed.

### EXAMPLE OF A PROCESS FOR OBTAINING SPECIFIC COMPOUNDS OF THE FORMULA (I), THE COMPOUNDS OF THE FORMULA (II TO VII)

The process consists of carrying out the two steps: preparation of the phenolate ion of 4-hydroxycoumarin and C-alkylation.

1. Preparation of the Phenolate ion of 4-hydroxycoumarin

The phenolate ion of 4-hydroxycoumarin can be obtained by carrying out the following steps:
in a flask, mix 20 mmol of 4-hydroxycoumarin with 10 ml of 1 M NaOH and 1.5 ml of 10 M NaOH until dissolution is complete, for complete solubilization, such that a slightly pale yellow solution is obtained,
reflux at 70° C. for 30 minutes to allow the formation of the coumarin phenolate.

2. Synthesis of Compounds II to VII

Starting from the mixture prepared under point 1., the following steps are carried out:
addition of 50 ml of ethanol,
addition of 25 mmol of brominated derivative, and
refluxing at 70° C.

The progress of the reaction is followed by HPLC analysis.

The brominated compounds are the following:
for compound (II): bromooctane C₈H₁₇Br
for compound (III): bromodecane C₁₀H₂₁Br
for compound (IV): bromododecane C₁₂H₂₅Br
for compound (V): bromotetradecane C₁₄H₂₉Br
for compound (VI): bromohexadecane C₁₆H₃₃Br
for compound (VII): bromooctadecane C₁₈H₃₇Br

The reaction medium is then purified. The purification of the reaction medium is carried out by liquid/liquid extractions (during these operations all the liquid phases are subjected to HPLC chromatography):
add 1 M sodium hydroxide to the medium until a medium of pH 14 is obtained,
wash with toluene, allow to separate and collect the oily interface with the alkaline phase,
extract the toluene phases with a 1 M solution of NaOH, and discard them,
combine the red-colored alkaline phases and extract with the aid of ethyl acetate,
discard the aqueous alkaline phase and wash the ethyl acetate phase with a solution of HCl,
discard the aqueous acid phases and wash the ethyl acetate phase with distilled water,
discard the aqueous phases and filter the ethyl acetate over anhydrous sodium sulfate,
wash the sodium sulfate with ethyl acetate and
evaporate the ethyl acetate using a sub-sack under a stream of nitrogen.

The final product can be in the form of a yellow to orange-tinged yellow oil or in the form of a white to yellowish powder, depending on the compounds.

The molecules obtained correspond to the formulae (II), (III), (IV), (V), (VI) and (VII).

Evaluation of the Efficacy (IC50) on Rats of Products of The Formulae (II) to (VII) by Comparison with 2 Other Products

The rodenticidal efficacy of compounds according to the invention was tested by comparison with products corresponding to the following formulae (VIII) and (IX):

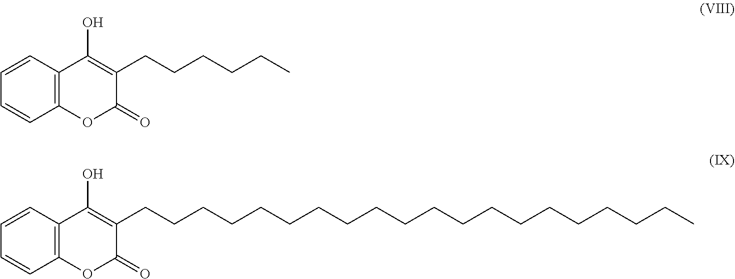 [SMILES: CCCCCCc1c(O)c2ccccc2oc1=O ; CCCCCCCCCCCCCCCCCCCCc1c(O)c2ccccc2oc1=O]

These products are obtained by the same process as that carried out for the formulae (II) to (VII), using as the brominated compounds:
for compound (VIII): bromohexane C₆H₁₃Br
for compound (IX): bromoeicosane C₂₀H₄₁Br

The intention is to determine the IC₅₀ (50% inhibitory concentration) of compounds of the formulae (II) to (IX) by measurement of the activity with respect to vitamin K in accordance with the operating protocol described below, after addition of increasing concentrations of compounds (II) to (IX).

The operating protocol is the following. Incubation is carried out in a 200 mM Hepes buffer (pH 7.4) containing 150 mM KCl in the presence of a reducing agent, dithiothreitol (1 mM):
with 0.5 to 1 mg of microsomal liver fractions from sensitive rats, and the reaction substrate,
with 200 μmol of vitamin K epoxide in a final volume of 1 ml.

The mixture is incubated for 30 minutes at 37° C. and the reaction is stopped by addition of 4 ml of a mixture of isopropanol/hexane (1:1).

The reaction mixture is then centrifuged for 10 minutes at 3,000 revolutions per minute.

The organic phase is collected and then evaporated to dryness under nitrogen.

The dry residue is immediately taken up in 200 μl of isopropanol.

The vitamin K is then analyzed. The products are separated by reverse chromatography on a C8 column using a mobile phase composed of methanol and acetic acid under isocratic conditions (1 ml/min) at 45° C. Detection of the product is carried out by MS/MS with an APCI source in positive mode.

The identification criteria for vitamin K are the retention time and the production of fragment 187 from the initial ion 451.

The IC50 values are evaluated by non-linear to linear regression from the equation of non-competitive inhibition:

v=(vₘₐₓ/(l+(I/Kᵢ)))*(S/(Kₘ+S))

where v represents the initial rate, I the concentration of anticoagulant, Kₘ the Michaelis-Menten constant, S the concentration of substrate (mM), Vₘₐₓ the maximum rate of reaction and Kᵢ the inhibition constant.

To demonstrate a rodenticidal effect, the IC50 must be less than or equal to 0.19 μM.

The results obtained are shown below:

| Compounds | IC50 (μM) |
|---|---|
| VIII | >0.2 |
| II | 0.15 |
| III | 0.06 |
| IV | 0.05 |
| V | 0.04 |
| VI | 0.04 |
| VII | 0.06 |
| IX | >0.5 |

These results show that in contrast to compounds VIII and IX, the compounds according to the invention have a rodenticidal effect with an IC50 of less than or equal to 0.19.

1. A compound corresponding to the formula (I): 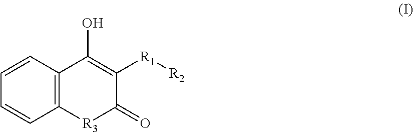
and its enantiomers, diastereoisomers, tautomers or mixtures of the latter in any proportions,
in which:
R1 represents: —H or 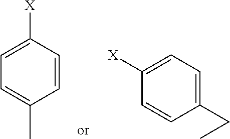
where X═H, OH, Cl, Br, F, CF₃ or NO₂,
R2 represents: 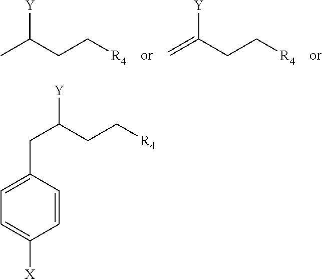
where X═H, OH, Cl, Br, F, CF₃ or NO₂,
R3 represents: O or S or CH—X,
where X═H, OH, Cl, Br, F, CF₃ or NO₂,
R4 represents a carbon chain chosen from the following: 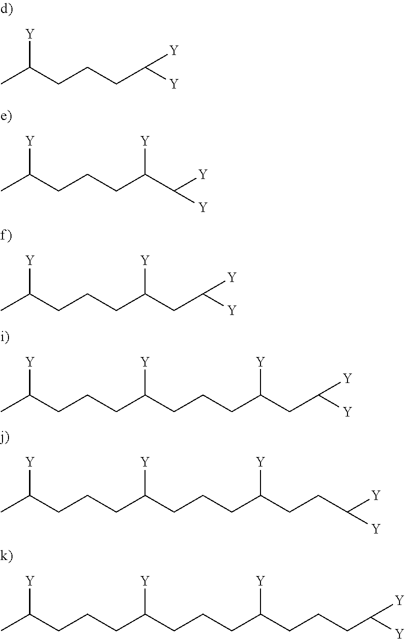
where Y═H or CH₃ when X═H, OH, Cl, Br, F, CF₃ or NO₂, 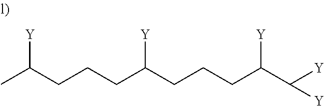
where Y═H when X═H, OH, Cl, Br, F, CF₃ or NO₂,
or where Y═CH₃ when X═CF₃,
X can be different or identical in R1, R2 or R3, and
Y can be different or identical when there are several Y in a same grouping R2.

2. A compound as claimed in claim 1, wherein R3 represents an oxygen O.

3. A compound as claimed in claim 1, wherein it corresponds to the formula (I) in which:
R1 represents —H,
R2 represents 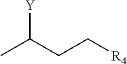
R3 represents O, and
R4 represents one of chains d), e), f), i), j), k), l), where Y═H.

4. A compound as claimed in claim 1, wherein R4 is chosen from chains d), e), f), i) and l), where Y═H.

5. A rodenticidal composition, wherein it comprises at least one compound as claimed in claim 1.

6. A rodenticidal composition as claimed in claim 5, wherein it comprises between 0.001 and 50% by weight of said at least one compound corresponding to.

7. A rodenticidal composition as claimed in claim 5, wherein it is in the form of a liquid concentrate, powder, grains, gels, pastes, or extruded baits, such as pellets or blocks.

8. A method for combating rodent pests, comprising applying at a location a rodenticidal composition comprising at least one compound corresponding to the formula (I): 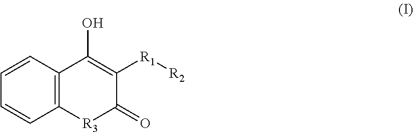
or one of its enantiomers, diastereoisomers, tautomers or mixtures of the latter in any proportions,
in which:
R1 represents: —H or 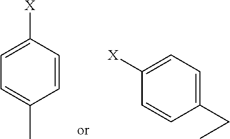
where X═H, OH, Cl, Br, F, CF₃ or N0₂,
R2 represents: 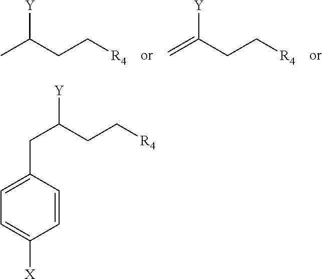
where X═H, OH, Cl, Br, F, CF₃ or NO₂,
R3 represents: O or S or CH—X,
where X═H, OH, Cl, Br, F, CF₃ or NO₂,
R4 represents a carbon chain chosen from chains a) to l): 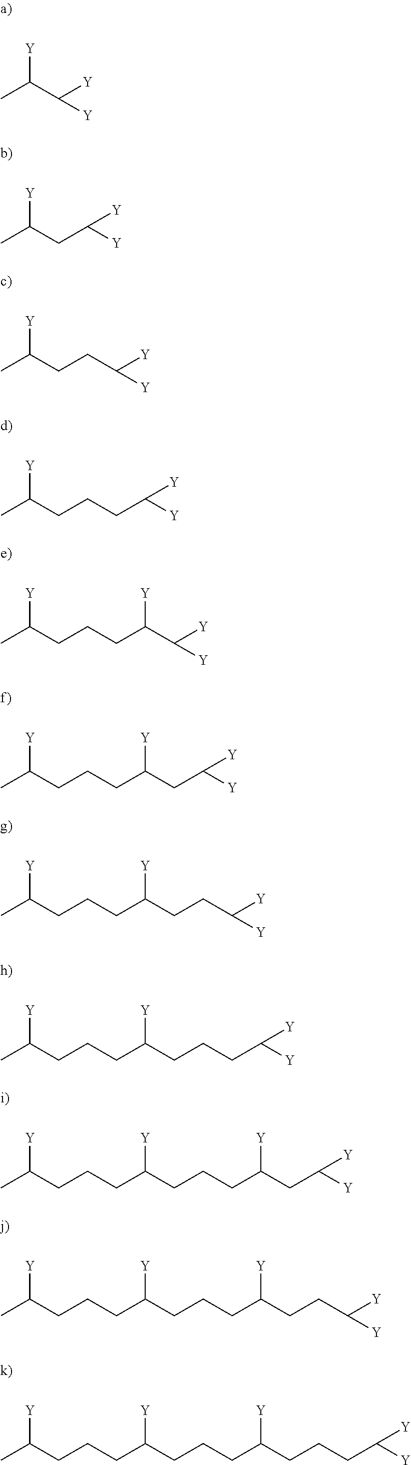
where Y═H or CH₃ when X═H, OH, Cl, Br, F, CF₃ or NO₂, 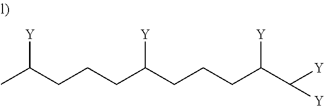
where Y═H when X═H, OH, Cl, Br, F, CF₃ or NO₂,
or where Y═CH₃ when X═CF₃,
X can be different or identical in R1, R2 or R3, and
Y can be different or identical when there are several Y in a same grouping R2.

9. The method as claimed in claim 8, wherein the location is in the domestic environment, in a rural, professional, urban medium, in public catering or reception places or also in the food processing industry for combating rats, mice, field mice, brown rats and/or any other rodent pest.

10. The method as claimed in claim 8, the compound being a compound wherein R3 represents an oxygen O.

11. The method as claimed in claim 8, wherein the compound corresponds to the formula (I) in which:
R1 represents —H,
R2 represents 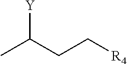
R3 represents 0, and
R4 represents one of chains d), e), f), i), j), k), l), where Y═H.

12. The method as claimed in claim 8, wherein R4 of the compound is chosen from chains d), e), f), i) and l), where Y═H.

13. The method as claimed in claim 9, wherein R3 of the compound represents an oxygen O.

14. The method as claimed in claim 9, wherein the compound corresponds to the formula (I) in which:
R1 represents —H,
R2 represents 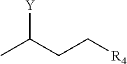
R3 represents 0, and
R4 represents one of chains d), e), f), i), j), k), l), where Y═H.

15. The method as claimed in claim 9, wherein R4 of the compound is chosen from chains d), e), f), i) and l), where Y═H.

16. The rodenticidal composition as claimed in claim 6, wherein the composition is in the form of a liquid concentrate, powder, grains, gels, pastes, or extruded baits, such as pellets or blocks.
